(19) United States
(12) Patent Application Publication
(10) Pub. No.: US 2018/0049444 A1
(43) Pub. Date: Feb. 22, 2018

(54) XENORHABDUS SZENTIRMAII METABOLITES, TRANS-CINNAMIC ACID, AND ANALOGS THEREOF AS ENHANCERS OF FUNGICIDAL ACTIVITY

(71) Applicants: The United States of America, as Represented by the Secretary of Agriculture, Washington, DC (US); Adnan Menderes University

(72) Inventors: David I. Shapiro Ilan, Macon, GA (US); Clive H. Bock, Warner Robins, GA (US); Selcuk Hazir, Aydin (TR)

(21) Appl. No.: 15/675,870

(22) Filed: Aug. 14, 2017

Related U.S. Application Data
(60) Provisional application No. 62/374,160, filed on Aug. 12, 2016.

(51) Int. Cl. A01N 63/00; A01N 37/10; A01N 43/54

(52) U.S. Cl. CPC A01N 63/00; A01N 43/54; A01N 37/10

(57) ABSTRACT

The fungicidal activity of TCA and cell-free extracts of X. szentirmaii is superior compared to other Xenorhabdus and Photorhabdus species. The effectiveness of TCA and X. szentirmaii metabolites to synergize and enhance fungicidal efficacy of commercial fungicides when combined with them at particular concentrations to suppress growth of Monilinia fructicola and Rhizoctonia solani was evaluated. Fungicidal activity was measured by phytopathogen growth on PDA plates with and without treatments. For suppression of M. fructicola, synergy was observed between TCA when combined with certain concentrations of Elast®, PropiMax®, Regalia® or Serenade®, and for combinations of X. szentirmaii, strain 17C+E, when combined with Abound®. For suppression of R. solani, synergy was observed between TCA combined with Regalia® or Serenade®. TCA combined with X. szentirmaii resulted in synergistic levels of suppression of M. fructicola. Utilizing TCA and X. szentirmaii for enhancing fungicidal activity improves control of phytopathogenic diseases and reduces environmental impact.

### REFERENCE TO RELATED APPLICATIONS

This application claims the benefit of U.S. Provisional Application No. 62/374,160 filed Aug. 12, 2016, which is incorporated herein by reference in its entirety.

### FIELD OF THE INVENTION

This invention relates to synergistic fungicidal combinations of trans-Cinnamic acid (TCA) and commercial fungicides and synergistic fungicidal entomopathogenic bacterial metabolites and commercial fungicides where use of these synergistic combinations act to enhance the fungicidal effectiveness of commercial fungicides for reducing germination and vegetative growth of phytopathogenic fungi, e.g., Venturia carpophila (peach scab), V. effusa (pecan scab), Monilinia fructicola (brown rot), Glomerella cingulata (anthracnose) and Rhizoctonia solani (wide host range and worldwide distribution) thus making it possible to use lesser amounts of the TCA and commercial fungicides and thereby address resistance and environmental concerns. The invention relates further to a particular entomopathogenic Xenorhabdus szentirmaii, strain 17C+E, screened for its synergistic antagonistic activity for suppressing these phytopathogenic fungi.

### BACKGROUND

The use of commercial chemical fungicides is problematic because of reduced sensitivity due to resistance issues and environmental concerns. Thus, it is important to develop alternative environmentally friendly fungicides for control of plant diseases. It has been shown previously by others that a number of safe entomopathogenic bacteria species/strains in the genera Xenorhabdus and Photorhabdus possess fungicidal activity. The crude bacterial exudates and metabolites of Photorhabdus spp. and Xenorhabdus spp. have been examined for toxicity against important fungal pathogens and all of these studies offered encouraging results (San Blas et al. 2012. Arch. Phytopath Plant Protect. 45:1950-1967; Bock et al. 2014. J. Pest Sci. 87:155-162; Shapiro et al. 2009. Arch. Phytopath Plant Protect. 42:715-728; Shapiro et al. 2014. Biol. Control 77:1-6; Fang et al. 2011. J. Appl. Microbiol. 111:145-154). It has been shown previously that these bacteria are effective against key pecan and peach diseases (Shapiro-Ilan & Reilly. 2013. U.S. Pat. No. 8,609,083). Also, it has been demonstrated that one of the bioactive compounds found in Photorhabdus species, trans-Cinnamic acid (TCA), is highly potent against pecan and peach fungal diseases (Bock et al. 2014).

Xenorhabdus spp. and Photorhabdus spp. bacteria are mutualistically associated with entomopathogenic nematodes in the genera Steinernema and Heterorhabditis, respectively (Lacey et al. 2015. J. Invert. Pathol. 132:1-41; Shapiro-Ilan et al. 2017. Basic and Applied Research; Entomopathogenic Nematodes. In: Microbial Agents for control of Insect Pests: From Discovery to Commercial Development and Use. L. A. Lacey (Ed.) Academic Press, pp. 253-267). In nature, these nematodes are lethal obligate parasites of insects and the nematode/bacterium complex works together as a biological unit to kill insect hosts. Each nematode species is specifically associated with only one bacterial species, although a bacterial species may be associated with more than one nematode species (Boemare et al. 1997. Symbiosis 22: 21-45; Fischer-Le Saux et al. 1999. FEMS Microbiol. Ecol. 29:149-157). The bacterial cells are carried in the intestinal tract of the only free-living dauer stage of the nematode, commonly referred as the infective juvenile.

Nematode infection occurs when infective juveniles enter the insect host through natural orifices (mouth, anus, and spiracles) or infective juveniles penetrate directly into the insect's hemocoel through the insect's cuticle. After penetration, the bacterial cells are released into the insect's hemocoel. Multiplying bacteria produce various toxins and virulence factors that are capable of disarming insect humoral and cellular responses, and which are primarily responsible for killing the host within 48-72 hours post-infection (Forst et al. 1997. Ann. Rev. Microbiol. 51:47-72). Depending on the size of the insect host, two or more nematode generations can occur in the cadaver. When nutrients are exhausted in the insect cadaver, the infective juvenile stage is formed and reinitiates the symbiosis by repossessing bacterial cells. Infective juveniles then exit the cadaver into the soil to search for a new host (Shapiro-Ilan et al. 2017).

Both nematode and bacteria contribute to the mutualistic relationship (Forst and Clarke. 2002. In: Entomopathogenic Nematology. R. Gaugler (Ed.), CABI Publishing, Wallingford, UK, pp. 57-77; Shapiro-Ilan et al. 2017). The symbiotic bacteria cannot survive outside the host and therefore, require the nematodes for distribution from one insect to another. The bacteria also benefit from nematode-induced inhibition of the host's antibacterial proteins. On the other hand, inside the insect cadaver, the bacteria serve as a direct food source to the nematodes, or supply nutrients through degradation of the insect cadaver.

For successful nematode reproduction, the insect cadaver has to be protected from secondary invasion by contaminating organisms and scavenging predators. Thus, another important function of the symbiotic bacteria is that they produce a large variety of antibiotic or antagonistic compounds which adversely affect opportunist bacteria, fungi, viruses, protozoa (Kaya, H. K. 2002. In: Entomopathogenic Nematology. R. Gaugler (Ed.), CABI Publishing, Wallingford, UK, pp. 189-204), and scavengers (Gulcu et al. 2012. J. Invert. Pathol. 110: 326-333). To date several antimicrobial compounds such as xenorhabdins, xenocoumacins, cabanillasin, and a range of indole derivatives have been isolated from Xenorhabdus species (Webster et al. 2002. In: Entomopathogenic Nematology. R. Gaugler (Ed.), CABI Publishing, Wallingford, UK, pp. 99-114). Likewise, hydroxystilbenes, trans-stilbenes, trans-Cinnamic acid (TCA), anthraquinone pigments and the toxin complex have been isolated from Photorhabdus species (Boemare and Akhurst. 2006. In: The Prokaryotes, Dworkin et al. (Eds.), Springer Science+Business Media Inc., New York, pp. 451-494; Bode, H. B. 2009. Curr. Opin. Chem. Biol. 13:1-7; Bock 2014). The anthraquinone pigments and the trans-stilbenes were determined as antibacterial (Boemare and Akhurst 2006), whereas trans-stilbenes and trans-Cinnamic acid (TCA) were described as antifungal compounds (Webster 2002; Bock et al. 2014).

Currently, use of many commercial fungicides is problematic due to environmental issues and development of resistance in the target pathogen. Therefore, there is a need for development of new fungicidal materials or approaches that are more benign to the environment or possess novel modes of action, including biological control. The advantage over existing technology would be a safe and effective environmentally friendly control mechanism for suppression of plant diseases. The impact and potential market could be considerable for control of plant diseases in peach, pecan and many other crops.

All of the references cited herein, including U.S. Patents and U.S. Patent Application Publications, are incorporated by reference in their entirety.

Mention of trade names or commercial products in this publication is solely for the purpose of providing specific information and does not imply recommendation or endorsement by the U.S. Department of Agriculture.

### SUMMARY

The inventors discovered that trans-Cinnamic acid (TCA) and the fungicidal metabolite of the entomopathogenic bacterium X. szentirmaii, strain 17C+E, can each enhance the fungicidal effects of commercial fungicides to suppress vegetative growth of phytopathogenic fungi.

In accordance with this discovery, it is an objective of the invention to provide synergistic compositions comprising combinations of TCA and commercial fungicides and combinations of the fungicidal supernatant of bacterium X. szentirmaii, strain 17C+E, and commercial fungicides for suppressing phytopathogenic fungi.

It is another objective of the invention to provide a method of biocontrol for suppressing fungal spore germination and vegetative growth of Venturia carpophila (peach scab, previously known as Fusicladium carpophila), V. effusa (pecan scab, formerly known as F. effusum), Monilinia fructicola (brown rot), Glomerella cingulata (anthracnose) and/or Rhizoctonia solani.

It is a further objective of the invention to provide a method for suppressing fungal spore germination and vegetative growth of phytopathogenic fungi by applying a synergistic fungicidal composition comprising TCA and the commercial fungicides Prophyt®, Regalia® and Serenade®, Elast®, PropiMax®, and Abound®, or the generic forms thereof, to a plant, tree, seed, or soil surrounding said plant, tree or seed, wherein the ratio of TCA and the commercial fungicide are so selected that the fungicidal activity is synergistically enhanced, and the amount of growth or sporulation of one or more phytopathogenic fungal populations on the living plant or tree is reduced.

It is further objective of the invention to provide a method for suppressing fungal spore germination and vegetative growth of phytopathogenic fungi by applying a synergistic fungicidal composition comprising the fungicidal metabolite of Xenorhabdus szentirmaii, strain 17C+E (NRRL B-67309), and the commercial fungicides Prophyt®, Regalia® and Serenade®, Elast®, PropiMax®, and Abound®, or the generic forms thereof, to a plant, tree, seed, or soil surrounding said plant, tree or seed, wherein the ratio of the fungicidal metabolite of Xenorhabdus szentirmaii, strain 17C+E (NRRL B-67309), and the commercial fungicide are so selected that the fungicidal activity is synergistically enhanced, and the amount of growth or sporulation of one or more phytopathogenic fungal populations on the living plant or tree is reduced.

It is an additional objective of the invention to provide environmentally friendly biocontrol compositions and methods of biocontrol for peach scab, pecan scab, brown rot and/or anthracnose.

Also part of this invention is a kit, comprising the synergistic fungicidal combinations of TCA or the fungicidal metabolite of Xenorhabdus szentirmaii, strain 17C+E (NRRL B-67309), and the commercial fungicides Prophyt®, Regalia® and Serenade®, Elast®, PropiMax®, and Abound®, or the generic forms thereof.

Other objectives and advantages of this invention will become readily apparent from the ensuing description.

### Deposit of Microorganisms

Xenorhabdus szentirmaii, strain 17C+E, designated NRRL B-67309, has been deposited under the provisions of the Budapest Treaty on Aug. 10, 2016 with the U.S.D.A. Agricultural Research Service Patent Culture Collection (National Center for Agricultural Utilization Research, 1815 N. University Street, Peoria, Ill., 61604).

The subject cultures have been deposited under conditions that assure that access to the cultures will be available during the pendency of this patent application to one determined by the Commissioner of Patents and Trademarks to be entitled thereto under 37 CFR 1.14 and 35 USC 122. The deposits are available as required by foreign patent laws in countries wherein counterparts of the subject application, or its progeny, are filed. However, it should be understood that the availability of a deposit does not constitute a license to practice the subject invention in derogation of patent rights granted by governmental action.

Further, the subject culture deposits will be stored and made available to the public in accord with the provisions of the Budapest Treaty for the Deposit of Microorganisms, i.e., they will be stored with all the care necessary to keep them viable and uncontaminated for a period of at least five years after the most recent request for the furnishing of a sample of the deposit, and in any case, for a period of at least 30 (thirty) years after the date of deposit or for the enforceable life of any patent which may issue disclosing the cultures. The depositor acknowledges the duty to replace the deposits should the depository be unable to furnish a sample when requested, due to the condition of the deposit(s). All restrictions on the availability to the public of the subject culture deposits will be irrevocably removed upon the granting of a patent disclosing them.

### BRIEF DESCRIPTION OF THE FIGURES

Advantages of embodiments of the present invention will be apparent from the following detailed description of the exemplary embodiments. The following detailed description should be considered in conjunction with the accompanying figures in which:

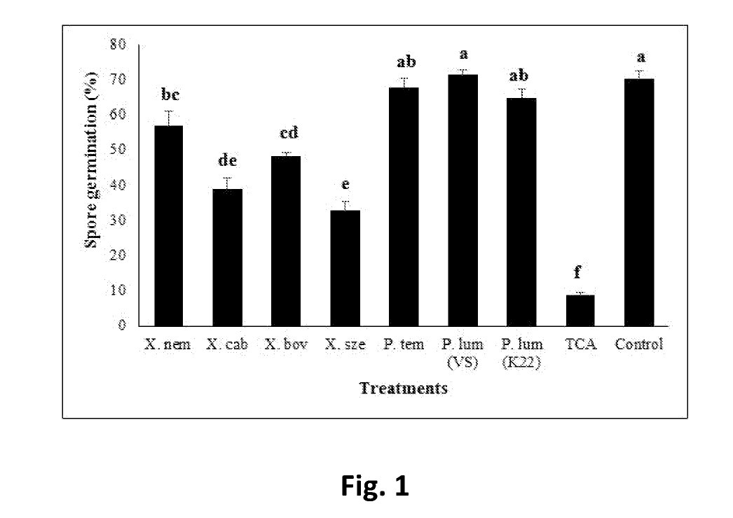

Exemplary FIG. 1 shows the percentage spore germination of Venturia carpophila in potato dextrose broth amended with 10% supernatant of different EPN bacteria cultures or TCA. X. nem=Xenorhabdus nematophila, X. cab=Xenorhabdus cabanillasii, X. boy=Xenorhabdus bovienii, X. sze=Xenorhabdus szentirmaii, P. tem=Photorhabdus temperate, P. lum (VS)=Photorhabdus luminescens (VS), P. lum (K22)=Photorhabdus luminescens (K22), TCA=trans-Cinnamic acid. Different letters above bars indicate statistical significance (Tukey's HSD test, α=0.05).

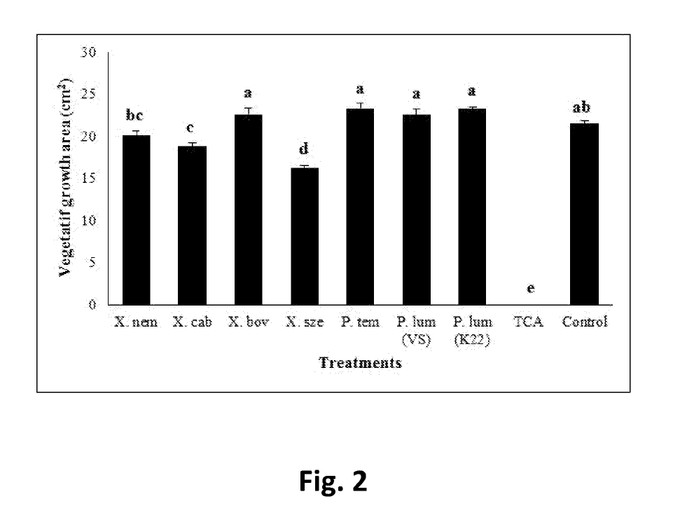

Exemplary FIG. 2 shows the colony area (cm²) of Glomerella cingulata on potato dextrose agar media amended with 10% supernatant of different entomopathogenic (EPN) bacteria cultures or TCA. X. nem=Xenorhabdus nematophila, X. cab=Xenorhabdus cabanillasii, X. boy=Xenorhabdus bovienii, X. sze=Xenorhabdus szentirmaii, P. tem=Photorhabdus temperate, P. lum (VS)=Photorhabdus luminescens (VS), P. lum (K22)=Photorhabdus luminescens (K22), TCA=trans-Cinnamic acid. Different letters above bars indicate statistical significance (Tukey's HSD test, α=0.05).

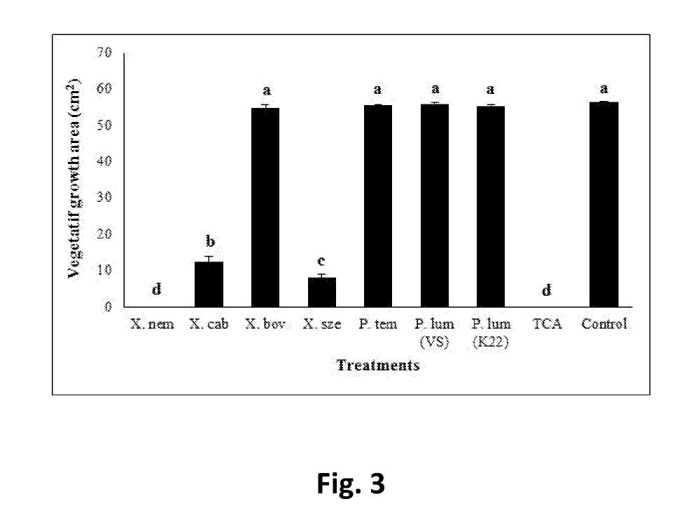

Exemplary FIG. 3 shows the colony area (cm²) of Monilinia fructicola on potato dextrose agar media amended with 10% supernatant of different EPN bacteria cultures or TCA. X. nem=Xenorhabdus nematophila, X. cab=Xenorhabdus cabanillasii, X. boy=Xenorhabdus bovienii, X. sze=Xenorhabdus szentirmaii, P. tem=Photorhabdus temperate, P. lum (VS)=Photorhabdus luminescens (VS), P. lum (K22)=Photorhabdus luminescens (K22), TCA=trans-Cinnamic acid.

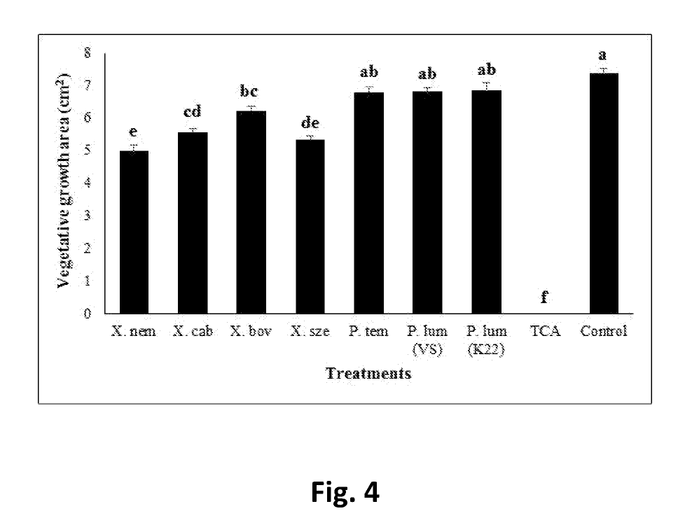

Different letters above bars indicate statistical significance (Tukey's HSD test, α=0.05). Exemplary FIG. 4 shows the colony area (cm²) of Venturia effusa on Saboraud Dextrose Agar media amended with 10% supernatant of different EPN bacteria cultures or TCA. X. nem=Xenorhabdus nematophila, X. cab=Xenorhabdus cabanillasii, X. boy=Xenorhabdus bovienii, X. sze=Xenorhabdus szentirmaii, P. tem=Photorhabdus temperate, P. lum (VS)=Photorhabdus luminescens (VS), P. lum (K22)=Photorhabdus luminescens (K22), TCA=trans-Cinnamic acid. Different letters above bars indicate statistical significance (Tukey's HSD test, α=0.05).

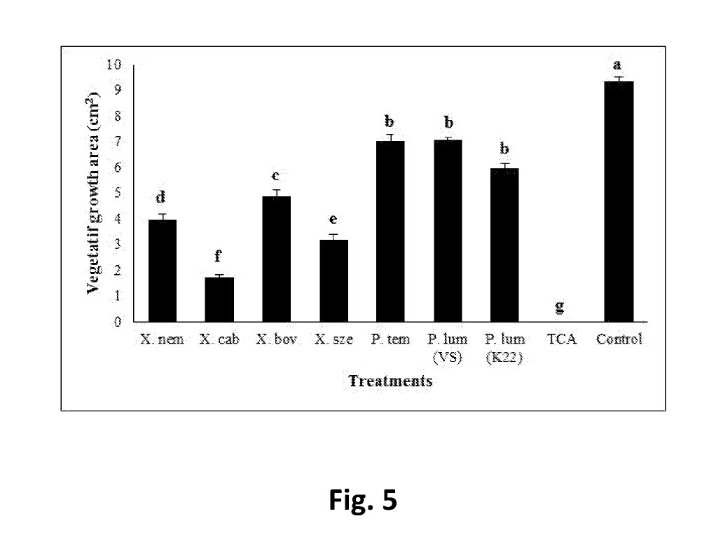

Exemplary FIG. 5 shows the colony area (cm²) of Venturia carpophila on Saboraud Dextrose Agar media amended with 10% supernatant of different EPN bacteria cultures or TCA. X. nem=Xenorhabdus nematophila, X. cab=Xenorhabdus cabanillasii, X. boy=Xenorhabdus bovienii, X. sze=Xenorhabdus szentirmaii, P. tem=Photorhabdus temperate, P. lum (VS)=Photorhabdus luminescens (VS), P. lum (K22)=Photorhabdus luminescens (K22), TCA=trans-Cinnamic acid. Different letters above bars indicate statistical significance (Tukey's HSD test, α=0.05).

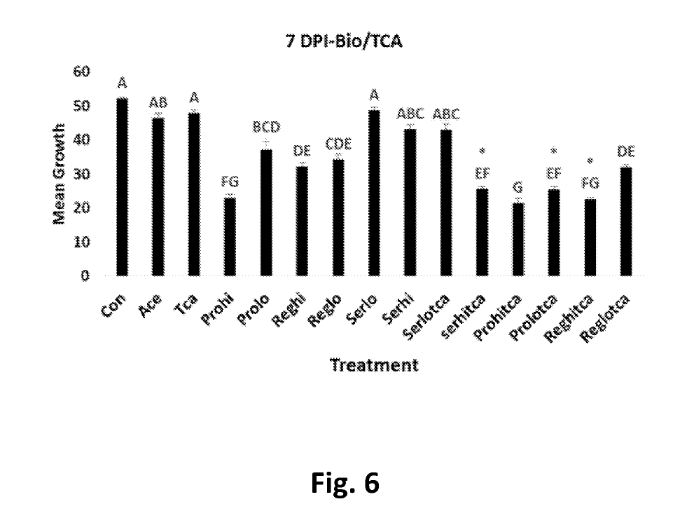

Exemplary FIG. 6 shows the mean vegetative growth of Monilinia fructicola on potato dextrose agar following treatments of trans-Cinnamic-acid (TCA), Prophyt® (Pro), Regalia® (Reg), Serenade® (Ser) or combinations thereof. “Hi” and “lo” refer to higher or lower rates of the fungicides (see Table 4 for details). Controls consisted of no amendment (Con) or Acetone only (Ace) (the solvent for TCA). Treatment effects were assessed 7 days after application. Different letters above bars indicate statistically significant differences (Tukey's test, α=0.05). Asterisks above bars indicate the combined treatment caused synergistic levels of suppression relative to the respective treatments applied alone.

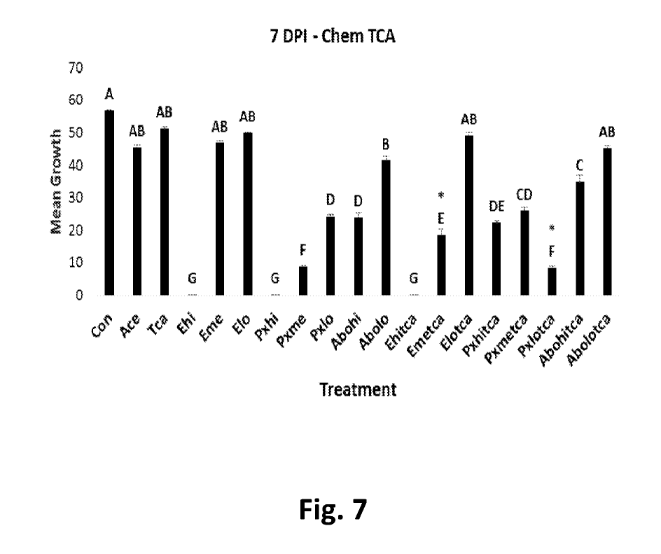

Exemplary FIG. 7 shows the mean vegetative growth of Monilinia fructicola on potato dextrose agar following treatments of trans-Cinnamic-acid (TCA), Elast® (E), PropiMax® (Px), Abound® (Abo) or combinations thereof. “Hi,” “lo,” and “me” refer to higher, lower and intermediate rates of the fungicides (see Table 4 for details). Controls consisted of no amendment (Con) or Acetone only (Ace) (the solvent for TCA). Treatment effects were assessed 7 days after application. Different letters above bars indicate statistically significant differences (Tukey's test, α=0.05). Asterisks above bars indicate the combined treatment caused synergistic levels of suppression relative to the respective treatments applied alone.

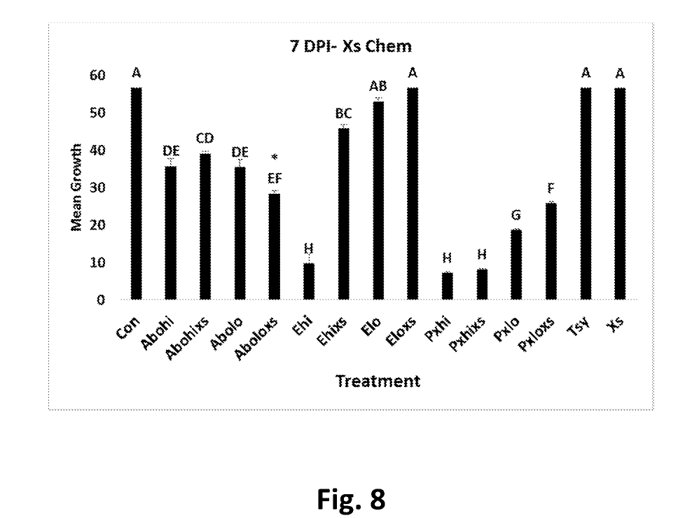

Exemplary FIG. 8 shows the mean vegetative growth of Monilinia fructicola on potato dextrose agar following treatments of Xenorhabdus szentirmaii metabolites (Xs), Abound® (Abo), Elast® (E), PropiMax® (Px), or combinations thereof. “Hi” and “lo” refer to higher or lower rates of the fungicides (see Table 4 for details). Controls consisted of no amendment (Con) or TSY (the culture broth for X. szentirmaii, strain 17C+E). Treatment effects were assessed 7 days after application. Different letters above bars indicate statistically significant differences (Tukey's test, α=0.05). Asterisks above bars indicate the combined treatment caused synergistic levels of suppression relative to the respective treatments applied alone.

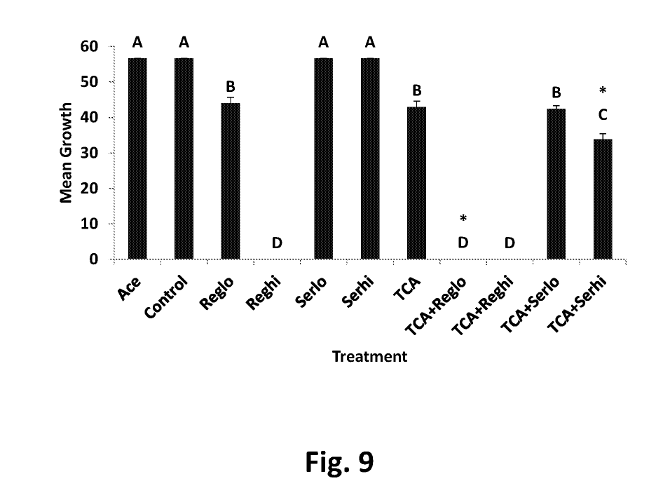

Exemplary FIG. 9 shows the mean vegetative growth of Rhizoctonia solani on potato dextrose agar following treatments of trans-Cinnamic-acid (TCA), Regalia® (Reg), Serenade® (Ser) or combinations thereof. “Hi” and “lo” refer to higher or lower rates of the fungicides (see Table 4 for details). Controls consisted of no amendment (Con) or Acetone only (Ace) (the solvent for TCA). Treatment effects were assessed 7 days after application. Different letters above bars indicate statistically significant differences (Tukey's test, α=0.05). Asterisks above bars indicate the combined treatment caused synergistic levels of suppression relative to the respective treatments applied alone.

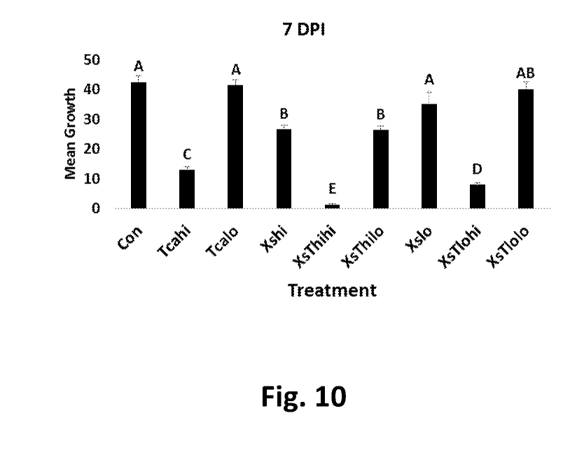

Exemplary FIG. 10 shows the mean vegetative growth of Monilinia fructicola on potato dextrose agar following treatments of trans-Cinnamic-acid (TCA), Xenorhabdus, strain 17C+E, metabolites, or combinations thereof. “Hi” and “lo” refer to higher or lower rates of the fungicides (see Table 4 for details). The controls (Con) consisted of no amendment. Treatment effects were assessed 7 days after application. Different letters above bars indicate statistically significant differences (Tukey's test, α=0.05). Asterisks above bars indicate the combined treatment caused synergistic levels of suppression relative to the respective treatments applied alone.

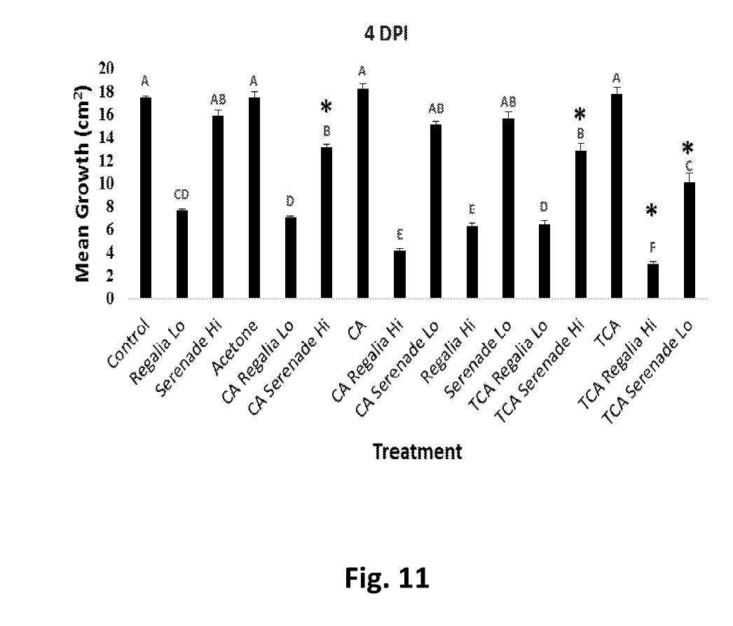

Exemplary FIG. 11 shows the mean vegetative growth of Monilinia fructicola on potato dextrose agar following treatments with trans-Cinnamic acid (TCA), cinnamaldehyde (CA), and different commercial fungicides. Different letters above bars indicate statistical differences (ANOVA with Tukey's test, alpha=0.05). An asterisk indicates a synergistic response relative to the individual agents applied alone (Chi-square>3.84 and observed value>expected value indicates synergy).

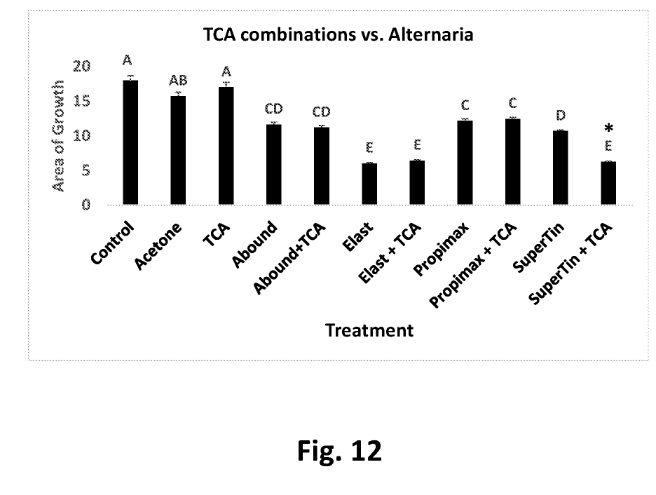

Exemplary FIG. 12 shows growth of Alternaria solani following treatments with TCA and different commercial fungicides. Different letters above bars indicate statistical differences (ANOVA with Tukey's test, alpha=0.05). An asterisk indicates a synergistic response relative to the individual agents applied alone (Chi-square=10.45 and observed value>expected value).

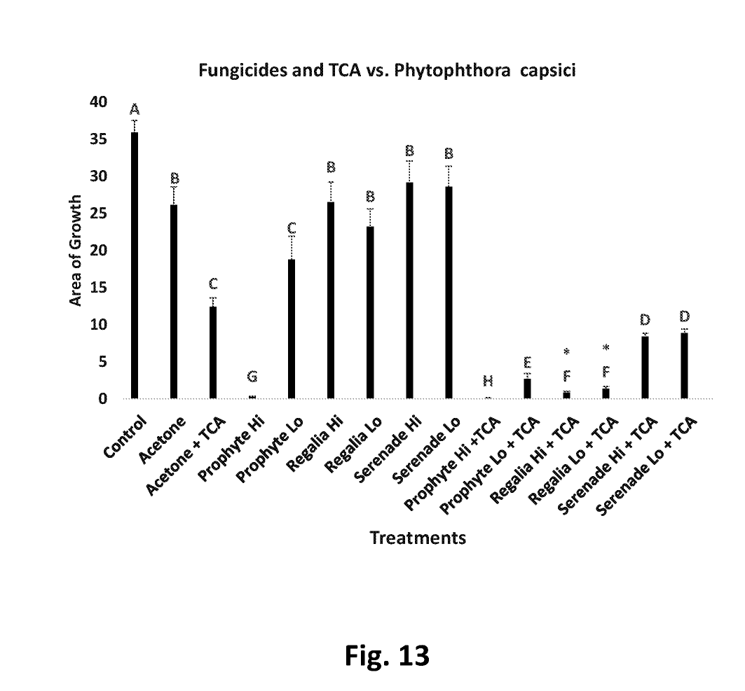

Exemplary FIG. 13 shows growth of Phytophthora capsici following treatments with TCA and different commercial fungicides. Different letters above bars indicate statistical differences (ANOVA with Tukey's test, alpha=0.05). An asterisk indicates a synergistic response relative to the individual agents applied alone (Chi-square=4.38 for the Regalia-Lo+TCA treatment and 7.2 for Regalia-Hi+TCA, and observed values>expected values).

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiment are not necessarily to be construed as preferred or advantageous over other embodiments. Moreover, the terms “embodiments of the invention,” “embodiments,” or “invention” do not require that all embodiments of the invention include the discussed feature, advantage or mode of operation.

Unless defined otherwise, all technical and scientific terms used herein have the same meaning as commonly understood by one of ordinary skill in the art to which the invention belongs. As used herein, the term “about” refers to a quantity, level, value, or amount that varies by as much as 30%, preferably by as much as 20%, and more preferably by as much as 10% to a reference quantity, level, value, or amount. Although any methods and materials similar or equivalent to those described herein can be used in the practice or testing of the present invention, the preferred methods and materials are now described.

Other compounds may be added to the composition provided they do not substantially interfere with the intended activity and efficacy of the composition; whether or not a compound interferes with activity and/or efficacy can be determined, for example, by the procedures utilized below.

The amounts, percentages, and ranges disclosed herein are not meant to be limiting, and increments between the recited amounts, percentages, and ranges are specifically envisioned as part of the invention.

The terms “effective amount” and “an amount effective [to]” of a compound or property as provided herein is meant such amount as is capable of performing the function of the compound or property for which an effective amount is expressed. As will be pointed out below, the exact amount required will vary from process to process, depending on recognized variables such as the compounds employed and the processing conditions observed. Thus, it may not be possible to specify an exact “effective amount.” However, an appropriate effective amount may be determined by one of ordinary skill in the art using only routine experimentation based on the disclosures herein.

“Fungicidal activity” or “fungicidal effect” refers to the ability of a compound or composition to (i) prevent the growth of a fungus, including the prevention of sporulation, (ii) inhibit the growth of a fungus or its sporulation, or (ii) substantially kill or eliminate a fungus population. A fungicide is a compound or composition which exhibits substantial fungicidal activity.

The term “treat,” “treating,” or “treatment,” as used herein, refers to the use of a fungicide to reduce or prevent a condition, symptom, or disease caused by a fungus by (i) preventing the growth of a fungus, including the prevention of sporulation, (ii) inhibiting the growth of a fungus or its sporulation, or (ii) substantially killing or eliminating a fungus population.

A “fungicidal enhancer” is a compound or composition which, when combined with a fungicide, substantially enhances the fungicidal activity of the fungicide. In particular, a fungicidal enhancer is a compound or composition which has a synergistic, rather than an additive, ability to increase the fungicidal activity of the fungicide.

As used herein, “analog” or “chemical variant” of a compound refers to a structural analog of the identified compound having a similar structure and similar activity. For example, one analog of trans-Cinnamic acid is cinnamaldehyde.

Combined application of different anti-fungal compounds can result in synergism resulting in improved efficacy and reduced potential for resistance development (Moreno-Martinez et al. 2015. Sci. Reports 5:16700 DOI: 10. 1038/srep16700). However, combination of pesticidal agents can also result in additive or antagonistic interactions (Shapiro-Ilan et al. 2004. Biol. Control 30:119-126; Shapiro-Ilan et al. 2017). One of the bioactive compounds found in Photorhabdus species is TCA. TCA by itself seems unlikely to be marketed as a fungicide, but an enhanced version based on combination with other materials could be quite potent.

TCA and metabolites from X. szentirmaii, strain 17C+E, possess higher antifungal activity than metabolites derived from a variety of other Xenorhabdus or Photorhabdus species (Examples 3 and 4; Hazir et al. 2017a. Eur. J. Plant Pathol. In Press, DOI 10.1007/s10658-017-1277-7). This finding held true when comparing potency against a variety of phytopathogens including major pathogens of peach, Armillaria tabescens (the causal agent of root rot), Venturia carpophila (causal agent of peach scab) and Monilinia fructicola (causal agent of brown rot), and pecan pathogens V. effusa (causal agent of pecan scab), and Glomerella cingulata (causal agent of anthracnose=Colletotrichum gloeosporioides). Some of these pathogens species or genera cause disease in a variety of other crops as well. Therefore, there is strong justification to explore further the potential role of Xenorhabdus and Photorhabdus metabolites in the control of plant diseases.

The inventors found that TCA activity can be greatly enhanced (synergistically) when combined with crude culture broth of other entomopathogenic bacteria such as Xenorhabdus szentirmaii, in particular, X. szentirmaii, strain 17C+E. Synergistic levels of suppression were observed against brown rot (Monilinia fructicola) when TCA was combined with cell-free broths of X. szentirmaii, strain 17C+E. Development of these combinations (or similar ones) as novel fungicides could have substantial impact on control of important plant diseases.

Synergy between fungicidal agents has been sought and observed previously (Moreno-Martinez 2015). For example, Baider and Cohen (2003. Phytoparasitica 31:399-409) reported BABA (DL-3-aminobutyric acid) and the protectant fungicide mancozeb were more effective than either agent applied alone in controlling late blight (Phytophthora infestans) in potato and tomato, and downy mildew (Pseudoperonospora cubensis) in cucumber. However, there is a dearth of examples that extend to field results. Furthermore, no reports to date have examined fungicidal interactions between metabolites of Xenorhabdus or Photorhabdus bacteria and commercial fungicides.

Interactions between TCA, TCA analogs, and metabolites from X. szentirmaii, strain 17C+E, when combined with commercial fungicides were evaluated. Phytopathogens included Monilinia fructicola and Rhizoctonia solani. For suppression of M. fructicola, synergy was observed between TCA when combined with particular concentrations of the commercial fungicides Elast®, PropiMax®, Regalia® or Serenade®, and for combinations of X. szentirmaii with Abound®. For suppression of R. solani, synergy was observed between TCA combined with Regalia® or Serenade®. Additionally, when TCA was combined with X. szentirmaii synergistic levels of suppression to M. fructicola were observed.

TCA analogs which may also be used in the present invention include cis-Cinnamic acid, cinnamaldehyde, hydrocinnamic acid. In general, TCA and analogs thereof may include any compound of the form:

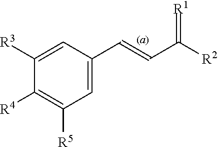

wherein R¹ is O or N; R² is OH, H, OCH₃, or an akyl chain of length 1-12; each of R³, R⁴, and R⁵ are one of H, OH, OCH₃, NH₂, CN, NO₂, Cl, or NR⁶R⁷, where each of R⁶ and R⁷ are one of H or an alkyl chain of length 1-12; and the bond designated by (a) is either a double bond or a single bond, and in the case of (a) being a double bond, the compound may be either the trans or cis isomer.

The present findings may hold promise for enhancing control of key phytopathogens in an effective and environmentally sound manner. Specifically, the use of bio-based fungicidal agents such as bacterial metabolites is likely to have lower environmental impact relative to broad spectrum chemicals. Thus, combinations using TCA or X. szentirmaii, strain 17C+E, in synergistic combinations with other fungicides considered biorational, e.g., Regalia® and Serenade®, could be particularly beneficial as efficacy is increased while minimizing environmental impact. However, synergistic combinations of TCA or X. szentirmaii, strain 17C+E, with conventional chemical fungicides will also be beneficial because higher efficacy may be achieved while the amount of chemical input into the system is reduced. Some of the synergistic interactions observed in the present study involved lower rates of the commercial fungicide, and therefore may have more potential for reduced environmental impact, e.g., TCA combined with Elast®, Prophyt® or Regalia®. Moreover, in one case the fungicide (Serenade®) did not produce any effect when applied alone for suppression of R. solani, yet synergistic suppression was achieved when the high rate was combined with TCA; thus, a fungicide that was ineffective may be made efficacious by adding TCA as an enhancer. Additional research is needed to explore the potential for TCA or X. szentirmaii, strain 17C+E supernatants (or other Xenorhabdus spp. or Photorhabdus spp. metabolites) as fungicide synergists in combination with other fungicides, and against other phytopathogens not tested in this study. Furthermore, research will be needed to confirm and optimize the synergistic interactions under field conditions.

The highly antagonistic metabolites of X. szentirmaii, strain 17C+E, are applied to fungi in amounts effective to reduce population levels of said fungi. As used herein “reduce population levels” refers to a reduction in numbers of M. fructicola propagules compared to that which would be expected in soil which was not treated according to the methods of the present invention. Any accurate method of measuring and comparing population levels may be used for such comparisons, as would be apparent to those skilled in the art.

### EXAMPLES

Having now generally described this invention, the same will be better understood by reference to certain specific examples, which are included herein only to further illustrate the invention and are not intended to limit the scope of the invention as defined by the claims.

Methods and Materials

Bacterial Extracts and Fungicides.

Four Xenorhabdus spp., two strains of Photorhabdus luminescens and one strain of P. temperata (7 bacterial isolates total; Table 1) were used in the assays. TCA was also included. The bacterial exudates and cell-free supernatants were isolated from the hemolymph of nematode-infected Galleria mellonella (Lepidoptera: Pyralidae) larvae according to Kaya and Stock (1997. Techniques in Nematology. In: Manuel of Techniques in Insect Pathology, L. A. Lacey (Ed.) Academic Press, San Diego, pp. 281-324). Photorhabdus spp. and Xenorhabdus spp. produce two colony form variants (phase-1 and phase-II). Phase-I has been reported to provide better support for nematode growth compared with phase-II and only phase-I produces antimicrobial compounds. Therefore, the phase-I form of the bacteria was used. The phase of the bacteria was determined by their cell and colony morphology on NBTA plates and by using the catalase test (Boemare and Akhurst 2006). Bacterial stock suspensions were kept in Tryptic Soy Broth (TSYB; Difco, Detroit, Mich.) with 20% glycerol at −80° C. until they were used in experiments (Boemare and Akhurst, 2006). As needed, the bacterial cells were taken from the frozen stock cultures and transferred directly to NBTA medium (nutrient agar with 0.004% (w/v) triphenyltetrazolium chloride and 0.025% (w/v) bromothymol blue). The growth of the bacteria and colony morphology were checked after 48 hours incubation to ensure that there was no contamination. A loopful of bacteria from NBTA medium was transferred to 100 ml TSYB plus 0.5% yeast extract (Sigma, St. Louis, Mo.) in an Erlenmeyer flask (300 ml capacity). The liquid cultures were incubated on a rotary incubator shaker at 130 or 200 rpm for 24 hours in the dark at 25° C. (Shapiro-Ilan et al. 2014; Hazir et al. 2017a). Subsequently, the bacterial broth was centrifuged at 10,000 rpm for 20 min at 4° C. The supernatant was filtered through a 0.22 m filter (Millipore, Thermo Scientific, NY). The bacterial exudates were poured into the 50 ml sterile centrifuge tubes (Corning, N.Y.) and kept at 4° C. for up to two weeks prior to use. TCA (98%+purity) was obtained from Acros Organics (New Jersey, USA). In addition, trans-Cinnamaldehyde (98%+purity) was obtained from Arcos Organics (New Jersey, USA).

TABLE 1
Mutualistic bacteria and their isolated nematode species.

| | Entomopathogenic | Strain |
|---|---|---|
| Mutualistic bacteria | Nematode Spp. (EPN) | Identifier* |
| Xenorhabdus bovienii | Steinernema feltiae | SN |
| Xenorhabdus nematophila | Steinernema carpocapsae | Cxrd |
| Xenorhabdus cabanillasii | Steinernema riobrave | 7-12 |
| Xenorhabdus szentirmaii | Steinernema rarum | 17c+e |
| Photorhabdus temperata | Heterorhabditis megidis | UK211 |
| Photorhabdus luminescens | Heterorhabditis bacteriophora | VS |
| Photorhabdus luminescens | Heterorhabditis floridensis | K-22 |

*all strains used were from the Entomopathogenic Nematode Collection, a US Federal Scientific Collection maintained by the US Department of Agriculture

The following fungicides were used in experiments: azoxystrobin (Abound®, Syngenta, Greensboro, N.C.), dodine (Elast®, Greensboro Port Washington, N.Y.), potassium phosphite (ProPhyt®, Helena Chemical Company, Collierville, Tenn.), propiconazole (PropiMax®, Dow, Indianapolis Ind.), a plant extract from Reynoutria sachalinensis (Regalia®, Marrone Bio Innovations, Davis Calif.), the bacterium Bacillus subtilis (Serenade®, Bayer CropScience LP Research Triangle Park, NC), and triphenyltin hydroxide (Super Tin®, United Phosphorus, King of Prussia, Pa.). To simulate applications and combinations that growers would apply, formulated commercial products were used in all experiments (rather than using the technical grade active ingredient alone). In addition, for ease of reference, in the following experiments and Examples, the names of the commercial formulations are used. However, it is envisioned that one of ordinary skill in the art could use the active ingredients, given above, in a composition other than the commercial products referred to in the practice of this invention using the present disclosure.

Phytopathogen Cultures.

The fungal cultures of Venturia carpophila (peach scab) and V. effusa (pecan scab) were isolated from peach and pecan trees, respectively, at the USDA-ARS research station in Byron, Ga., USA. Both were cultured on potato dextrose agar (PDA). The cultures of Monilinia fructicola (brown rot) and Glomerella cingulata (anthracnose) were isolated from peach trees at the USDA-ARS research station in Byron, Ga., USA, and were also cultured on PDA. Rhizoctonia solani was isolated from the roots of cotton seedlings in Aydin, Turkey. The isolate of Alternaria solani was obtained from a blighted tomato plant in Gray, Ga. and was cultured on PDA. The isolate of Phytophthora capsici was obtained from a collection at the University of Georgia, Tifton, Ga., and was cultured on V8 agar. All fungi were grown in Petri dishes at 25° C.-27° C. and were stored for up to one week at 4° C. prior to experimentation. Depending on the experiment, either a 5 mm diameter mycelia plug from a fungal culture plate was transferred to the center of each experimental agar dish and growth subsequently monitored, or suspensions of conidia the fungus were prepared in sterile distilled water for subsequent experimental use. Suspensions of V. effusa (2×10⁴ conidia/ml) and of V. carpophila (1×10³ conidia/ml) were prepared from cultures after 3 weeks of incubation. Suspensions of spores of A. solani (1×10³ conidia/ml) were prepared after 1 week of incubation. Inoculum of Phytophthora capsici was prepared after approximately 1 week of incubation as macerated mycelium with approximately 1×10⁴ mycelial fragments/ml. For R. Solani, only mycelial plugs were used. Mycelial plugs were taken from similarly aged cultures of each species, respectively.

### Example 1: Suppression of Spore Germination in Peach and Pecan Scab

The spores of V. carpophila and V. effusa were used to determine the inhibitory effect of the bacterial supernatants on germination. Supernatants tested were from X. nematophila, X. cabanillasii, X. bovienii, X. szentirmaii, strain 17C+E, P. temperate, P. luminescens (VS) and P. luminescens (K-22). The conidia suspension (0.1 ml) of V. effusa or V. carpophila was added to 0.8 ml potato dextrose broth (PDB) in 2 ml eppendorf tubes containing 0.1 ml (10% v/v) bacterial supernatant. Controls were PDB alone and conidial suspension without supernatant. Because TCA derived from Photorhabdus spp. was identified as an active compound with significant antifungal activity (Bock et al. 2014), TCA was added (1.27 mg/ml) in all experiments for comparison as well. The stock solution of TCA (99% purity, Sigma, St. Louis, Mo.) was prepared with 12.7 g dissolved in 100 ml ethanol (96%). Each treatment was replicated three times, and the experiment was repeated once on a different date. The tubes were incubated at 25° C. for 48 hours and the first 100 conidia were counted under the microscope (400×) to determine percentage spore germination (which was used to determine treatment effects). The other fungi (M. fructicola, and G. cingulata) did not produce spores as readily as V. carpophila and V. effusa, so these other phytopathogens were not assessed for effects of supernatant on spore germination. An inhibition rate was determined according to the formula: 100×[(the average percentage of spores germinated in the control−the average percentage of spores germinated in the treatment)/the average percentage of spores germinated in the control] (Fang et al. 2011). Analysis of Variance (ANOVA) (SAS V9.3, SAS Institute Inc., Cary, N.C.) was also applied to the data for V. carpophila.

Results of spore germination are shown in Table 2 and FIG. 1. TCA treatment caused the highest level of suppression followed by supernatants of X. szentirmaii, strain 17C+E. Only 8.66% of the fungal spores germinated with the TCA treatment. However, fungal spore germination ranged between 65% and 71% for the control and for all treatments with Photorhabdus spp (FIG. 1). The percentage spore germination of V. effusa was the least in the TCA treatment and highest in the control (Table 2).

TABLE 2
Inhibition rate of spore germination (%) of different plant pathogens by supernatants of
different EPN bacteria^{a} cultures.

| | | | | | | P. lum | P. lum | |
|---|---|---|---|---|---|---|---|---|
| | X. nem | X. cab | X. bov | X. sze | P. tem | (VS) | (K-22) | TCA |
| V. carpophila | 18.99 | 44.65 | 31.35 | 53.2 | 3.32 | −1.66 | 7.59 | 87.65 |
| V. effusa | 60.39 | 64.85 | 60.69 | 61.02 | 34.81 | 45.68 | 35.14 | 76.68 |

^{a}X. nem = Xenorhabdus nematophila; X. cab = Xenorhabdus cabanillasii; X. bov = Xenorhabdus bovienii; X. sze = Xenorhabdus szentirmaii, strain 17C+E; P. tem = Photorhabdus temperate; P. lum (VS) Photorhabdus luminescens (VS); P. lum (K-22) = Photorhabdus luminescens (K-22); TCA = trans-Cinnamic acid.

### Example 2: Suppression of Vegetative Growth in Peach and Pecan Scab

Treatment effects were compared by measuring in vitro vegetative growth of the phytopathogens V. carpophila and V. effusa when exposed to the same bacterial exudates evaluated above in the germination study. Solutions of the fungicidal treatments were incorporated into PDA and autoclaved. Prior to autoclaving the PDA, the prescribed volume of distilled water was reduced to allow addition of treatment suspensions. Controls consisted of PDA without any amendment or PDA with acetone only (the solvent for TCA). The media were vortexed when cooled to 40-42° C. and poured to Petri dishes.

A 5 mm diameter mycelia plug from a fungal culture plate was transferred onto the center surface of each agar dish (Fang et al. 2011; Hazir et al. 2017a) and incubated at 25° C. Vegetative growth of the fungus was measured after 7 days. Growth was measured in two perpendicular directions to obtain the approximate area of the fungal mat.

For G. cingulata, TCA caused the most suppression followed by X. szentirmaii, strain 17C+E (FIG. 2). For M. fructicola, TCA and X. nematophila caused the greatest suppression followed by X. szentirmaii, strain 17C+E (FIG. 3). Toward suppression of V. effusa, TCA caused the highest suppression followed by X. nematophila and then X. szentirmaii, strain 17C+E (FIG. 4). For V. carpophila, TCA caused the most suppression followed by X. cabanillasii and then X. szentirmaii, strain 17C+E (FIG. 5). To determine which bacterial treatment was most effective, a ranking of first, second, or third highest suppression was conducted among the three bacteria that caused the highest level in at least one experiment (X. cabanillasii, X. nematophila, and X. szentirmaii, strain 17C+E). Table 3 indicates that X. szentirmaii, strain 17C+E was overall superior in suppression of fungal growth based on its ranking relative to other bacterial metabolites. Also, X. szentirmaii, strain 17C+E, was the only treatment that always produced the highest suppression or second highest among bacteria (never third) in all experiments.

TABLE 3
Ranking of top bacterial metabolites in suppression
(1^{st}, 2^{nd}, 3^{rd}) for each phytopathogen. The lowest overall
score indicates superiority in fungal suppression.

| | G. scingulata | M. fructicola | V. effusa | V. carpophila | SCORE |
|---|---|---|---|---|---|
| X. cabanillasii | 2 | 3 | 3 | 1 | 9 |
| X. nematophila | 3 | 1 | 1 | 3 | 8 |
| X. szentirmaii, | 1 | 2 | 2 | 2 | 7 |
| strain 17C+E | | | | | |

TCA caused the greatest level of suppression in all experiments. Among the bacterial supernatants, X. szentirmaii, strain 17C+E, was superior in suppressing spore germination and vegetative growth and therefore is superior in suppressing phytopathogenic fungi.

### Example 3: Effects of Fungicidal Agents Applied Alone or in Combination

TCA and the bacterial exudates of X. szentirmaii, strain 17C+E (associated with the nematode, Steinernema rarum), were tested alone and in combination with commercially available fungicides. Treatment effects were compared by measuring in vitro vegetative growth of the phytopathogens when exposed to fungicidal agents applied alone or in combination; the approach was based on methods described above. Solutions of the fungicidal treatments were incorporated into PDA and autoclaved. Prior to autoclaving the PDA, the prescribed volume of distilled water was reduced to allow addition of treatment suspensions. Controls consisted of PDA without any amendment or PDA with acetone only (the solvent for TCA). The media were vortexed when cooled to 40-42° C. and poured to Petri dishes.

A 5 mm diameter mycelia plug from a fungal culture plate was transferred onto the center surface of each agar dish and incubated at 25° C. Vegetative growth of the fungus was measured after 7 days. Growth was measured in two perpendicular directions to obtain the approximate area of the fungal mat.

Prior to experimentation, a dose-response test was conducted for each fungicidal treatment and each phytopathogen (data not shown). Various rates of the fungicidal treatments (TCA, X. szentirmaii, strain 17C+E, and commercial fungicides) were applied individually and assessed for fungicidal activity against each phytopathogen as described above. The goal was to obtain a level of fungal suppression that was intermediate for the individual treatment, i.e., approximately 30 to 60% suppression, so that synergistic or additive effects would be clearly apparent when tested together with other fungicidal treatments.

A series of experiments were designed based on the dose-response tests, and selection of fungicide concentrations. The list of experiments, single treatments and their rates of application (and treatment abbreviations) is provided in Table 4. All commercial fungicides were applied at two rates: high rate (hi) and low rate (lo); and, in one case, a medium rate (me) was also used. Multiple rates were applied because application rate can impact the type of interaction between two agents (Koppenhöfer and Grewal. 2005. Compatibility and interactions with agrochemicals and other biocontrol agents. In: Nematodes as Biological Control Agents, Grewal et al. (Eds.), CABI Publishing, Wallingford, UK, pp. 363-381). Within each experiment, all of the fungicidal treatments (TCA, X. szentirmaii, strain 17C+E, and commercial fungicides) were applied individually. Moreover, TCA or the X. szentirmaii, strain 17C+E, supernatant was combined with each of the commercial fungicides at each concentration within an experiment. Two experiments with TCA and the commercial fungicides were run against M. fructicola (Experiments 1 & 2), one experiment with M. fructicola and X. szentirmaii, strain 17C+E (Experiment 3), and one experiment with TCA and R. solani (Experiment 4) (see Table 4). Within each experiment, there were nine replicate plates for each treatment, and each experiment was repeated once in time (hence two trials). Additionally, one trial was conducted to explore the combination of TCA with X. szentirmaii, strain 17C+E, as potential synergists of each other; this experiment also targeted M. fructicola (Experiment 5).

TABLE 4
List of experiments and treatments used to assess suppression
of vegetative growth in fungal phytopathogens^{a}

| Expt. | | | | | |
|---|---|---|---|---|---|
| # | Pathogen + Treatment | Treatment | % Conc^{b} | % Field rate^{c} | Abbre^{d} |
| 1 | M. fructicola + TCA | Acetone | 0.2 | NA | Ace |
| | | ProPhyt ® | 0.5 | 100 | Prohi |
| | | ProPhyt ® | 0.25 | 50 | Prolo |
| | | Regalia ® | 0.5 | 100 | Reghi |
| | | Regalia ® | 1 | 50 | Reglo |
| | | Serenade ® | 0.0003 | 0.02 | Serhi |
| | | Serenade ® | 0.00015 | 0.01 | Serlo |
| | | TCA | 0.2 | NA | TCA |
| 2 | M. fructicola + TCA | Abound ® | 0.01 | 0.05 | Abohi |
| | | Abound ® | 0.001 | 0.005 | Abolo |
| | | Acetone | 0.2 | NA | Ace |
| | | Elast ® | 0.0001 | 0.0005 | Ehi |
| | | Elast ® | 0.00001 | 0.00005 | Elo |
| | | Propimax ® | 0.0001 | 0.0005 | Pxhi |
| | | Propimax ® | 0.00001 | 0.00005 | Pxlo |
| | | TCA | 0.2 | NA | TCA |
| 3 | M. fructicola + X. szentermaii | Abound ® | 0.01 | 0.05 | Abohi |
| | | Abound ® | 0.001 | 0.005 | Abolo |
| | | Elast ® | 0.001 | 0.005 | Ehi |
| | | Elast ® | 0.0001 | 0.0005 | Eme |
| | | Elast ® | 0.00001 | 0.00005 | Elo |
| | | ProPhyt ® | 0.5 | 100 | Prohi |
| | | ProPhyt ® | 0.25 | 50 | Prolo |
| | | Propimax ® | 0.001 | 0.005 | Pxhi |
| | | Propimax ® | 0.0001 | 0.0005 | Pxme |
| | | Propimax ® | 0.00001 | 0.00005 | Pxlo |
| | | Regalia ® | 0.5 | 100 | Reghi |
| | | Regalia ® | 1 | 50 | Reglo |
| | | Serenade ® | 0.0003 | 0.02 | Serhi |
| | | Serenade ® | 0.00015 | 0.01 | Serlo |
| | | TSYB | 10 | NA | Tsy |
| | | X. szentirmaii | 10% | NA | Xs |
| 4 | Rhizoctonia solani + TCA | Acetone | 0.2 | NA | Ace |
| | | Regalia ® | 0.5 | 100 | Reghi |
| | | Regalia ® | 1 | 50 | Reglo |
| | | Serenade ® | 0.0003 | 0.02 | Serhi |
| | | Serenade ® | 0.00015 | 0.01 | Serlo |
| | | TCA | 0.2 | NA | TCA |
| 5 | M. fructicola with | TCA | 0.25 | NA | TCAhi |
| | TCA + X. szentirmaii, | TCA | 0.03 | NA | TCAlo |
| | strain 17C+E | X. szentirmaii | 5 | NA | Xshi |
| | | X. szentirmaii | 1 | NA | Xslo |

^{a}Phytopathogens included Monilinia fructicola, or Rhizoctonia solani. Within each experiment, trans-Cinnamic-acid (TCA) or Xenorhabdus szentirmaii, strain 17C+E, was combined with each of the other treatments, and all fungicidal treatments were also applied alone. All treatments were incorporated into potato dextrose agar (PDA). Acetone (the solvent of TCA) was used as a control, and an untreated control (no amendment) was also included in all experiments.
^{b}Percentage (v/v) per 500 ml potato dextrose agar. Prior to incorporation, TCA was dissolved in acetone at 10 mg/ml.
^{c}Percentage (v/v) of recommended field rate.
^{d}Abbreviation used in the text and figures.

Treatment effects for experiments testing in vitro antimycotic activity (based on area of fungal growth) were analyzed using ANOVA. Data from repeated trials were pooled and trial was considered as a block effect. If a significant treatment effect was detected in the ANOVA (α=0.05), a means separation was performed using Tukey's HSD test. The area of vegetative growth (cm²) was log transformed prior to analysis; non-transformed means are presented in the results.

The nature of interactions (antagonism, additivity, or synergy) between fungicidal agents was determined through a comparison of expected and observed fungal growth (Koppenhöfer and Kaya. 1997. Biol. Control 8:131-137; Shapiro-Ilan et al. 2011. J. Econ. Entomol. 104:14-20). Corrected fungicidal suppression was calculated based on Abbott's formula, i.e., (growth in the control—growth in the treatment)/growth in the control (Abbott, W. S. 1925. J. Econ. Entomol. 18:265-267). Subsequently, the expected additive proportional suppression S_{E} for combination treatments was calculated by S_{E}=S_{C}+S_{M} (1−S_{C}), where S_{C} and S_{M} are proportional suppression caused by commercial fungicide and bacterial metabolites (TCA or X. szentirmaii, strain 17C+E) applied alone, respectively. A chi-square (χ²) value was calculated as (S_{CM}−S_{E})2/S_{E}, where S_{CM} is the observed suppression for the combination of commercial fungicide and bacterial metabolites. If the calculated value was >3.84 (as specified for 1 degrees of freedom (df)), a non-additive effect of the two control agents was indicated. A positive value for the difference S_{CM}−S_{E} indicated synergy, whereas a negative value indicated antagonism.

In the first experiment with M. fructicola and TCA, differential in fungal suppression and interactions were observed among the treatments (F=31.27; df=14,240; P<0.0001) (FIG. 6; Table 5). Based on chi-square results, synergistic levels of fungal suppression (as indicated by reduced fungal growth) were observed at certain concentrations of all three commercial fungicides (Prophyt®, Regalia® and Serenade®) when combined with TCA (Table 5). Specifically the combination treatments ProloTCA, ReghiTCA, and SerhiTCA, were synergistic (Table 5). Furthermore, according to the ANOVA, all three of these combination treatments were in the lowest statistical group for fungal growth, and fungal growth in these combinations were lower than each of their respective treatments applied alone (FIG. 6). Fungal growth in the combination treatment ProhiTCA was also in the lowest statistical grouping, but this treatment did not differ from the high rate of Prophyt® applied alone. Other combination treatments were additive (Table 5).

TABLE 5
List of chi-square values and interactions for combined fungicidal treatments.^{a}

| | | Treatment | | |
|---|---|---|---|---|
| Expt. | Pathogen + Treatment | Combination^{b} | Chi-square | Interaction |
| 1 | Monilinia fructicola + TCA | TCA + Serenade-lo | 0.753588252 | Additive |
| | | TCA + Serenade-hi | 29.96186631 | Synergistic |
| | | TCA + Prophyte-hi | 0.499013839 | Additive |
| | | TCA + Prophyte-lo | 7.826168042 | Synergistic |
| | | TCA + Regalia-hi | 4.120990928 | Synergistic |
| | | TCA + Regalia-lo | 0.029198133 | Additive |
| 2 | Monilinia fructicola + TCA | TCA + Elast-hi | 1.14034E−05 | Additive |
| | | TCA + Elast-med | 66.77938759 | Synergistic |
| | | TCA + Elast-lo | 2.423059442 | Additive |
| | | TCA + PropiMax-hi | 15.28139511 | Antagonistic |
| | | TCA + PropiMax-med | 11.75188694 | Antagonistic |
| | | TCA + Propimax-lo | 9.227071724 | Synergistic |
| | | TCA + Abound-hi | 8.879275233 | Antagonistic |
| | | TCA + Abound-lo | 5.620861631 | Antagonistic |
| 3 | Monilinia fructicola + Xs | Xs + Abound-hi | 1.009025 | Additive |
| | | Xs + Abound-lo | 3.946475 | Synergistic |
| | | Xs + Elast-hi | 49.10311 | Antagonistic |
| | | Xs + Elast-lo | 6.588946 | Antagonistic |
| | | Xs + PropiMax-hi | 0.027503 | Additive |
| | | Xs + Propimax lo | 2.458579 | Additive |
| 4 | Rhizoctonia solani + TCA | TCA + Regalia-lo | 83.75610867 | Synergistic |
| | | TCA + Regalia-hi | 0 | Additive |
| | | TCA + Serenade-lo | 0.03692118 | Additive |
| | | TCA + Serenade-hi | 10.59377153 | Synergistic |
| 5 | M. fructicola with TCA + | Xs-hi + TCA-hi | 3.167351 | Additive |
| | X. szentirmaii, strain 17C+E | Xs-hi + TCA-lo | 22.90543 | Antagonistic |
| | | Xs-lo + TCA-hi | 80.04454 | Synergistic |
| | | Xs-lo + TCA-lo | 21.200562 | Antagonistic |

^{a}Chi-square values were generated by comparing observed and expected fungicidal activity of treatments applied alone or in combination; >3.84 indicates significance.
^{b}lo = lower rate of application, hi = higher rate of application, see text and Table 4.

Similarly in the second experiment with M. fructicola and TCA, differences in fungal suppression and interactions among fungicidal agents were observed (F=1008.43; df=18,321; P<0.0001) (FIG. 7; Table 5). Synergistic levels of fungal suppression were observed in certain concentrations of Elast® and PropiMax® (Table 5). In contrast, TCA interacted antagonistically with both rates of Abound® (Table 5). Both combination treatments that showed synergy also had lower fungal growth than the respective treatments applied separately (FIG. 7). Some of the fungicidal treatments when applied alone caused complete suppression of M. fructicola, i.e., the high rates of Elast® and PropiMax®, and thus there was no opportunity for synergy (FIG. 7).

In Experiment 3, treatment effects were observed when cell-free X. szentirmaii, strain 17C+E, supernatant and commercial fungicides were applied alone or in combination for suppression of M. fructicola (F=304.82; df=14,254; P<0.0001) (FIG. 8). Synergy was only observed in the combination of X. szentirmaii, strain 17C+E, +Abound® (low rate), whereas combinations with Elast® were antagonistic at both rates, and combinations with PropiMax® were additive at both rates (Table 5). Similar to the previous experiment, the high rates of Elast® and PropiMax® caused complete suppression, and thus there was no opportunity for synergy (FIG. 8).

Treatment differences and differential interactions were observed when TCA was combined with commercial fungicides against R. solani (Experiment 4, F=10752.9; df=10,186; P<0.0001) (FIG. 9; Table 5). Fungal suppression was synergistic when TCA was combined with one concentration of either Regalia® or Serenade® (Table 5). TCA and the low rate of Regalia® each caused<25% suppression when applied alone but the combination caused 100% suppression (Table 5). Serenade® did not cause any suppression when applied alone at either rate yet combinations with TCA caused significant suppression, and the combination with the high rate was synergistic (Table 5). Both treatments that showed synergy, also had lower fungal growth than their respective singly applied treatments (FIG. 9). The high rate of Regalia® caused 100% suppression of R. solani and thus there was no opportunity for synergy (FIG. 9).

In Experiment 5, when TCA was applied with X. szentirmaii, strain 17C+E, only one of the four rate combinations synergistically suppressed M. fructicola (F=198.94; df=8, 72; P<0.0001) (FIG. 10; Table 5). The synergistic combination, XsloTCAhi, resulted in less growth than either fungicidal agent applied alone (FIG. 10). In contrast, the other rate combinations were antagonistic or additive (Table 5).

In conclusion, overall, the data indicated a broad spectrum of synergistic interactions among the fungicidal agents. Toward M. fructicola suppression, TCA was synergistic with concentrations of all six of the commercial fungicides tested except Abound®. However, the cell-free supernatant of X. szentirmaii, strain 17C+E, was synergistic with Abound (though not synergistic with the other two fungicides tested). For suppression of R. solani, TCA was synergistic with both of the fungicides tested, Serenade® and Regalia®. Also, TCA was synergistic with X. szentirmaii, strain 17C+E, (for M. fructicola suppression) albeit at only one of the four combined concentrations. Thus, it is clear that an array of synergistic interactions can be achieved for fungicidal activity, yet the outcome is dependent on concentration of the fungicide. Therefore, concentrations to achieve maximum control of the targeted phytopathogens will have to be optimized specifically for each combination. The impact of concentration on level of interaction (synergy, additivity or antagonism) has been observed in other systems such as combinations of entomopathogens with each other or with chemical pesticides.

### Example 4: Other Related Compounds to TCA Also Display Synergistic Effects

Following the procedures above and those in Hazir et al (2017b, J. Invertebrate Path. 145: 1-8), synergy assessments were implemented to compare trans-Cinnamic acid to an exemplary analog, trans-Cinnamaldehyde. The target phytopathogen was Monilinia fructicola (brown rot).

Treatment effects were compared by measuring vegetative growth of the phytopathogens in vitro when they were exposed to the fungicidal agents applied alone or in combination. Solutions of the fungicidal treatments were incorporated into potato dextrose agar (PDA) to achieve the desired concentrations, and autoclaved. Prior to autoclaving the PDA, the prescribed volume of distilled water was reduced to allow addition of the fungicide solutions. Controls consisted of PDA without any amendment or PDA with acetone only (the solvent used for TCA). Trans-Cinnamic acid and trans-Cinnamaldehyde were applied alone or with commercial fungicides Regalia® (extract of Reynoutria sachalinensis) or Serenade® (Bacillus subtilis). After 4 days the area of M. fructicola growth was determined.

A full list of treatments is displayed in Table 6 below.

TABLE 6
List of treatments comparing synergistic effects of trans-
Cinnamic acid (TCA) and trans-Cinnamaldehyde (CA).

| Treatment #/Name | | Treatment type |
|---|---|---|
| 1 | control | water |
| 2 | acetone | PDA with .5 ml “old” acetone |
| | | added to 499 mls |
| 3 | TCA | 499.5 ml PDA + 0.5 ml TCA (500 mg |
| | | TCA in 50 ml Acetone) |
| 4 | CA | 499.5 ml PDA + 0.5 ml CA (500 mg |
| | | CA in 50 ml Acetone) |
| 5 | Regalia lo | PDA with 5 ml added to 495 mls |
| 6 | Regalia hi | PDA with 2.5 ml Regalia added to |
| | | 497.5 mls |
| 7 | Serenade hi | PDA with .016 serenade added to |
| | | 499.984 mls |
| 8 | Serenade lo | PDA with.008 serenade added to |
| | | 499.992 mls |
| 9 | TCA-Serenade hi | PDA with .5 ml TCA and .016 |
| | | serenade to 499.484 mls |
| 10 | TCA-Serenade lo | PDA with .5 ml TCA and .008 |
| | | serenade to 499.492 mls |
| 11 | TCA -Regalia hi | PDA with .5 ml TCA and 5 ml |
| | | regalia to 494.5 mls |
| 12 | TCA-Regalia lo | PDA with .5 ml TCA and 2.5 ml |
| | | regalia to 497 mls |
| 13 | CA-Serenade hi | PDA with .5 ml CA and .016 |
| | | serenade to 499.484 mls |
| 14 | CA-Serenade lo | PDA with .5 ml CA and .008 |
| | | serenade to 499.492 mls |
| 15 | CA -Regalia hi | PDA with .5 ml CA and 5 ml |
| | | regalia to 494.5 mls |
| 16 | CA-Regalia lo | PDA with .5 ml CA and 2.5 ml |
| | | regalia to 497 mls |

FIG. 11 shows that both TCA and CA can provide synergistic levels of M. fructicola suppression when combined with commercial fungicides such as Regalia and Serenade. Recent literature indicates that various forms of Cinnamic acid can suppress plant pathogenic fungi (Zhou et al., 2017. PLoS One 12(4): e0176189), and here we show that variant forms of Cinnamic acid are also synergistic in their suppression abilities when combined with commercial fungicides.

### Example 5: Synergistic Suppression Between TCA and Other Fungicides Targeting Additional Fungi

A. Solani.

Following the above procedures, interactions between trans-Cinnamic acid (TCA) and commercial fungicides azoxystrobin (Abound®), dodine (Elast®), and triphenyltin hydroxide (Super Tin®) were evaluated for suppression of A. solani, a major pathogen of tomatoes and potatoes.

FIG. 12 shows a synergistic interaction between TCA and Super Tin® for suppression of A. solani. The other treatment combinations showed significant suppression relative to the controls but the interactions were not synergistic. This supports further that select fungicidal combinations will result in synergy in suppression of a diverse array of plant pathogenic fungi.

P. capsici.

Following the same bioassay procedures as described above, interactions between TCA and fungicides Prophyte®, Regalia® and Serenade® were evaluated.

FIG. 13 shows synergistic interactions between TCA and Regalia for suppression of P. capsici. The other treatment combinations showed significant suppression relative to the controls (and superior control compared with the single-applied treatments) but the interactions were not synergistic. This supports further that select fungicidal combinations will result in synergy in suppression of a diverse array of plant pathogenic fungi.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A synergistic fungicidal composition comprising:
a fungicide; and
a fungicidal enhancer,
wherein said fungicidal enhancer is at least one of (a) the fungicidal metabolite of Xenorhabdus szentirmaii, strain 17C+E (NRRL B-67309), (b) trans-Cinnamic acid (TCA), or (c) an analog of TCA, and
wherein the amount of the fungicidal enhancer is in an amount effective to synergistically enhance a fungicidal effect of said fungicide to suppress the growth and sporulation of phytopathogenic fungi.

2. The composition of claim 1, wherein said phytopathogenic fungi are any one of Venturia carpophila, V. effusa, Monilinia fructicola, Glomerella cingulata, Rhizoctonia solani, Alternaria solani, and Phytophthora capsici.

3. The composition of claim 1, wherein said fungicidal enhancer is one of TCA or an analog of TCA, and said fungicide is any one of the commercial fungicides Prophyt, Regalia, Serenade, Elast, PropiMax, Abound, and Super Tin.

4. The composition of claim 3, wherein the fungicidal enhancer has a chemical structure of the form: 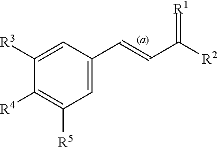
wherein R¹ is O or N; R² is OH, H, OCH₃, or an akyl chain of length 1-12,
wherein each of R³, R⁴, and R⁵ are one of H, OH, OCH₃, NH₂, CN, NO₂, Cl, or NR⁶R⁷, and each of R⁶ and R⁷ are one of H or an alkyl chain of length 1-12, and
wherein the bond designated by (a) is either a double bond or a single bond, and in the case of (a) being a double bond, the compound may be either the trans or cis isomer.

5. The composition of claim 1, wherein said fungicidal enhancer is one of TCA or an analog of TCA, and said fungicide is any one of azoxystrobin, potassium phosphite, a plant extract from Reynoutria sachalinensis, the bacterium Bacillus subtilis, dodine, propiconazole, and triphenyltin hydroxide.

6. The composition of claim 5, wherein the fungicidal enhancer has a chemical structure of the form: 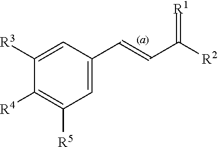
wherein R¹ is O or N; R² is OH, H, OCH₃, or an akyl chain of length 1-12,
wherein each of R³, R⁴, and R⁵ are one of H, OH, OCH₃, NH₂, CN, NO₂, Cl, or NR⁶R⁷, and each of R⁶ and R⁷ are one of H or an alkyl chain of length 1-12, and
wherein the bond designated by (a) is either a double bond or a single bond, and in the case of (a) being a double bond, the compound may be either the trans or cis isomer.

7. The composition of claim 1, wherein said fungicidal enhancer is the fungicidal metabolite of X. szentirmaii, strain 17C+E, and said fungicide is Abound.

8. The composition of claim 1, wherein said fungicidal enhancer is the fungicidal metabolite of X. szentirmaii, strain 17C+E, and said fungicide is azoxystrobin.

9. The composition of claim 1, wherein a ratio of the amount of the fungicide and the amount of the fungicidal enhancer is such that the fungicidal activity is synergistically enhanced.

10. The composition of claim 1, wherein the fungicide is one of TCA or an analog of TCA, and the fungicidal enhancer is the fungicidal metabolite of X. szentirmaii, strain 17C+E.

11. The composition of claim 1, wherein the fungicide is the fungicidal metabolite of X. szentirmaii, strain 17C+E, and the fungicidal enhancer is one of TCA or an analog of TCA.

12. A method for reducing the amount of growth or sporulation of one or more phytopathogenic fungal populations on a living plant or tree comprising:
(a) applying to a plant, tree, seed, or to soil surrounding said plant, tree, or seed, the synergistic fungicidal composition of claim 1 in an amount effective to reduce the growth or sporulation of the phytopathogenic fungal populations; and
(b) thereby reducing the amount of growth or sporulation of one or more phytopathogenic fungal populations on the living plant or tree.

13. The method of claim 12,
wherein the fungicidal enhancer is at least one of TCA or an analog of TCA, and
wherein the fungicide is at least one of the commercial fungicides Prophyt, Regalia, Serenade, Elast, PropiMax, Abound, and Super Tin.

14. The method of claim 12,
wherein the fungicidal enhancer is at least one of TCA or an analog of TCA, and
wherein the fungicide is at least one of azoxystrobin, potassium phosphite, a plant extract from Reynoutria sachalinensis, the bacterium Bacillus subtilis, dodine, propiconazole, and triphenyltin hydroxide.

15. The method of claim 12,
wherein the fungicidal enhancer is the fungicidal metabolite of X. szentirmaii, strain 17C+E (NRRL B-67309), and
wherein the fungicide is Abound.

16. The method of claim 12,
wherein the fungicidal enhancer is the fungicidal metabolite of X. szentirmaii, strain 17C+E (NRRL B-67309), and
wherein the fungicide is azoxystrobin.

17. The method of claim 12,
wherein the fungicide is one of TCA or an analog of TCA, and
wherein the fungicidal enhancer is the fungicidal metabolite of X. szentirmaii, strain 17C+E.

18. The method of claim 12,
wherein the fungicide is the fungicidal metabolite of X. szentirmaii, strain 17C+E, and
wherein the fungicidal enhancer is one of TCA or an analog of TCA.

19. The method of claim 12, wherein the phytopathogenic fungal populations are any one of Venturia carpophila, V. effusa, Monilinia fructicola, Glomerella cingulata, Rhizoctonia solani, Alternaria solani, and Phytophthora capsici.

20. A biocontrol method for treating at least one of peach scab, pecan scab, brown rot and anthracnose by reducing the amount of growth or sporulation of one or more phytopathogenic fungal populations on a living plant or tree according to claim 12.

21. The biocontrol method of claim 20, comprising reducing the amount of growth or sporulation of one of Venturia carpophila, V. effusa, Monilinia fructicola, Glomerella cingulata, Rhizoctonia solani, Alternaria solani, and Phytophthora capsici.
